(19) United States
(12) Patent Application Publication
(10) Pub. No.: US 2026/0005556 A1
(43) Pub. Date: Jan. 1, 2026

(54) AXIAL-FLUX STATOR CORE

(71) Applicant: Koenigsegg Automotive AB, Ängelholm (SE)

(72) Inventors: András Péter SZÉKELY, Ängelholm (SE); Rickard ERIKSSON HÄLL, Eket (SE); Dragos-Mihai POSTARIU, Strövelstorp (SE); Martin KRÜGER BECK, Ängelholm (SE)

(73) Assignee: Koenigsegg Automotive AB, Ängelholm (SE)

(21) Appl. No.: 19/112,861

(22) PCT Filed: Sep. 18, 2023
(86) PCT No.: PCT/EP2023/075671

§ 371 Date: Mar. 18, 2025

(30) Foreign Application Priority Data
Sep. 19, 2022 (EP) 22196350.7

(51) Int. Cl. H02K 1/14; H02K 15/026; H02K 15/027; H02K 15/085

(52) U.S. Cl. CPC H02K 1/146; H02K 15/026; H02K 15/027; H02K 15/085; H02K 2215/00

(57) ABSTRACT

An axial flux stator core (50) and a manufacturing thereof is proposed. The axial flux stator core (50) has a spirally layered structure (24), wherein the axial flux stator core (50) comprises a metal strip (14) having a longitudinal first side (16) and a longitudinal second side (18) and that is wound to form the spirally layered structure (24). The first side (16) of the metal strip (14) has a plurality of slots (20) having a slot width that vary along the metal strip (14), the first side (16) forms a plurality of stator teeth (26), the slots (20) define a tooth separation between each pair of neighboring stator teeth (26), and the second side (18) forms an annular stator yoke (28) connecting the stator teeth (26).

### TECHNICAL FIELD

The proposed technology generally relates to the field of axial flux motors and generators, and in particular to axial flux stators.

### BACKGROUND

An axial flux motor, or axial gap motor, is an electric motor having an architecture in which the magnetic flux between the rotor and the stator is aligned parallel with the axis of rotation.

One type of axial flux stators has an annular stator yoke with stator teeth extending axially relative to the stator yoke. The stator yoke and the stator teeth jointly form a stator core. Coils of an electrically insulated conductor, such as a wire or a flat copper strip, are wound around each stator tooth for forming a magnetic field parallel with the axis of rotation. It is known to manufacture such axial flux stator cores from a metal strip by forming a plurality of slots in one side of a metal strip and winding the metal strip to form a spirally layered structure. The side without slots forms the annular stator yoke and the side with the slots forms the stator teeth. The slots define the tooth separation between the stator teeth. The slots have a fixed shape, which means that the tooth separation does not depend on the radius. The innermost and outermost layers of the spirally layered structure have the same toot separation as the rest of the layers. In extension, this means that the stator teeth have a radial profile with sharp corners at the innermost and outer most layers.

Axial flux motors are typically shorter and wider than equivalent radial flux motors. In some applications it is an advantage to have a narrower width, for example when mounted coaxially on a drive shaft or drive axle in a car. The diameter of the stator generally sets the width of an axial flux motor. Additionally, in axial flux stators having a core with a spirally layered structure, the coils on the stator teeth protrude radially outward from the stator yoke and stator teeth, thus contributing to the diameter of the stator.

### SUMMARY

It is an object of the proposed technology to provide a greater flexibility in the forming the coils on the stator teeth in axial flux stators. It is a further object of the proposed technology to reduce the width of axial flux stators having a spirally layered structure.

In a first aspect of the proposed technology, a method is proposed for manufacturing an axial flux stator core from a metal strip, or elongated metal sheet, having a longitudinal first side and a longitudinal second side. The method comprises: forming a plurality of slots in the first side of the metal strip, wherein each slot has a slot width, and the slot widths vary, or change, along the metal strip, or the first side. The method further comprises: winding, or rolling, the metal strip to form a spirally layered, or laminated, structure, wherein the first side forms a plurality of stator teeth, the slots define a tooth separation, or tooth gap, between each pair of neighboring stator teeth, and the metal strip forms an annular stator yoke connecting the stator teeth.

In a second aspect of the proposed technology, a system is proposed for manufacturing an axial flux stator core from a metal strip, or elongated metal sheet, having a longitudinal first side and a longitudinal second side. The system comprises: a punching tool configured for forming a plurality of slots in the first side of the metal strip, wherein each slot has a slot width and the slot widths vary, or change, along the metal strip, or the first side. The system further comprises: a rolling tool, or winding roller, configured for winding, or rolling, the metal strip to form a spirally layered, or laminated, structure, wherein the first side forms a plurality of stator teeth, the slots define a tooth separation, or tooth gap, between each pair of neighboring stator teeth, and the metal strip forms an annular stator yoke connecting the stator teeth.

In a third aspect of the proposed technology, an axial flux stator core is proposed having a spirally layered, or laminated, structure, wherein the axial flux stator core comprises a metal strip, or elongated metal sheet, having a longitudinal first side and a longitudinal second side and that is wound to form the spirally layered structure. The first side of the metal strip has a plurality of slots, each slot has a slot width, and the slot widths vary, or change, along the metal strip, or the first side. The first side forms a plurality of stator teeth, the slots define a tooth separation, or tooth gap, between each pair of neighboring stator teeth, and the metal strip forms an annular stator yoke connecting the stator teeth.

In a fourth aspect of the proposed technology, a method is proposed for manufacturing an axial flux stator. The method may comprise any of the steps or features of the first aspect of the proposed technology. Additionally, the method further comprises: forming, or winding, a coil of an electrically insulated conductor on each of the stator teeth.

In a fifth aspect of the proposed technology, an axial flux stator is proposed comprising the axial flux stator core according to the third aspect of the proposed technology. The axial flux stator further comprises: a plurality of coils individually positioned on, or wound around, the stator teeth. Worded differently, the axial flux stator further comprises: a plurality of coils, wherein each coil is individually positioned on, or wound around, one of the stator teeth. Worded differently, the axial flux stator further comprises: a plurality of coils, wherein each stator tooth is fitted with a coil of the plurality of coils. It is understood that each coil is positioned on, or wound around, the stator tooth it is fitted on. It is understood that the coils are electromagnetic coils. It is further understood that each coil may comprise an electrically insulated conductor.

For example, the axial flux stator core or the axial flux stator may be for an electric motor or an electric generator. In a sixth aspect of the proposed technology, an axial flux motor or generator is proposed comprising the axial flux stator core according to the third aspect of the proposed technology, or the axial flux stator according to the fifth aspect of the proposed technology.

It is understood that the slot widths are aligned with the metal strip, or parallel to the first side of the metal strip. The varying slot widths along the metal strip means that the tooth separation varies radially relative in the spirally layered structure. This contributes to a greater flexibility in the forming the coils on the stator teeth and allows for an optimization of the radial profile of the stator teeth. For example, the radial profile can be adapted for different types or dimensions and shapes of the insulated conductors forming the coils wound around the stator teeth.

The metal strip may be of silicon steel or an electrical steel. It is understood that the forming of the plurality of slots and the winding of the metal strip are synchronized such the slots overlap in the spirally layered structure and form the stator teeth at the first side of the metal strip.

It is understood that the axial flux stator core defines an axial direction, a radial direction, and a tangential direction relative to the axis of rotation during use, for example in an electric motor or generator. Similarly, the spirally layered structure defines an axial direction, a radial direction, and a tangential direction relative to the axis of rotation during winding of the metal strip. The axis of rotation during use and during winding may be the same, which means that the mentioned directions coincide. For example, the axial direction is the same both during use and during winding.

A longitudinal side is here understood as running lengthwise relative to the strip. It is specified that the slots have a slot width that vary, or change, along the metal strip. It is understood that the longitudinal first side and a longitudinal second side may be parallel. It is specified that the slot widths vary along the metal strip. Worded differently, consecutive slots may have different slot widths. It is understood that each tooth extends radially, tangentially, and axially relative to the spirally layered structure. It is further understood that each slot extends tangentially and axially. It is further understood that the tooth separation is aligned tangentially to the spirally layered structure.

Each slot may define a first slot edge and a second slot edge on the metal strip, wherein the first slot edge and the second slot edge are spaced apart and connected to, or extend from, the first side of the metal strip. It is understood that the separation of the first slot edge and the second slot edge defines the slot width. Each slot may further define a third slot edge, wherein the third slot edge is spaced apart from the first side of the metal strip and interconnects the first slot edge and the second slot edge. The first slot edge and the second slot edge may be straight, or linear. The first slot edge and the second slot edge may be parallel. This means that each slot has a constant slot width going from the third slot edge to the first side of the metal strip. The first slot edge and the second slot edge may be transverse to, or perpendicular to, the first side of the metal strip. It is understood that the third slot edge may be straight, or linear, and that the third slot edge may be perpendicular to the first slot edge and the second slot edge, or aligned with, or parallel to, the first edge of the metal strip. Worded differently, the slot width of each slot may be constant, or unchanging, transverse to the metal strip, or perpendicular to the first side of the metal strip. Worded differently, each slot may outline a rectangle that is open at the first side of the metal strip. The constant width of a slot allows for it to be formed by two or more notching using the same cooperating punch and die. It also allows for a pre-wound coil to be pushed onto a stator tooth. In extension, this allows for the use of flat conductors in the coils with a broad side or a narrow side of the conductors facing the stator tooth.

In the axial-flux stator, it is understood that each coil may conform to the stator tooth it is formed or positioned on. It is specified above that in the fourth aspect of the proposed technology, the method comprises: forming a coil of an electrically insulated conductor on each of the stator teeth. It is understood that this encompasses forming a plurality of coils separate from the stator core and mounting a coil of the plurality of coils on each of the stator teeth, or pushing a coil of the plurality of coils onto each of the stator teeth. It is specified above that in the fifth aspect of the proposed technology, the coils are individually positioned on the stator teeth. Worded differently, each stator tooth is fitted with a coil of the plurality of coils. It is further specified that each coil may comprise an electrically insulated conductor. Each coil may be a prefabricated coil. This means that the coil has been formed, or wound, separate from the stator core.

For example, the conductor of each coil may be flat conductor strip that has a first broad side and a first narrow side. The first broad side may be arranged to face the stator tooth on which the coil is wound or mounted. This means that the first broad side constitutes an inner side of the conductor or coil. Worded differently, the coil may be a radially expanding multi-layer flat-conductor coil. Alternatively, the first narrow side may be arranged to face the stator tooth on which the coil is wound or mounted. This means that the first narrow side constitutes an inner face of the conductor or coil. Worded differently, the coil may be an axially expanding single-layer flat-conductor coil. It is understood that the conductor may have a second broad side that faces in the opposite direction relative to the first broad side, and that the first narrow side may interconnect the first broad side and the second broad side. It is further understood that the conductor may have a second narrow side that faces in the opposite direction relative to the first narrow side, and that the second narrow side may interconnect the first broad side and the second broad side. In these two examples, it is understood that coil is arranged such that the first broad side is juxtaposed to, or contacts, the second broad side within the coil.

The spirally layered structure may have a plurality of spirally, or radially, arranged layers. It is understood that the layers contact one another to form a radially sandwiched structure. It is further understood that the spirally layered structure encompasses a radially outermost layer and a radially innermost layer. The slots of a layer, or each layer, of the spirally layered structure may have the same slot width.

The spirally arranged structure may have a radially inner half and a radially outer half that jointly form the spirally arranged structure. It is understood that the inner half and the outer half join at the middle between the innermost layer and the outermost layer. It is further understood that the innermost layer forms part of the inner half and the outermost layer forms part of the outer half. It is further understood that the innermost layer and the outermost layer respectively are composed of a plurality of the layers. The slot widths of the slots in the radially outermost layer may be greater than the slot widths of the slots in the other layers of the outer half. The slot widths of the slots in the radially innermost layer may be greater than the slot widths of the slots in the other layers of the inner half.

The slot width of slots in in the outermost layer may be greater than the slot width in the neighboring second outermost layer. Similarly, the slot width of slots in in the second outermost layer may be greater than the slot width in the neighboring third outermost layer. Similarly, the slot width of slots in in the third outermost layer may be greater than the slot width in the neighboring fourth outermost layer. The slot width in the innermost layer may be equal to or greater than the slot width in the neighboring second innermost layer. The slots width may be the same in and between the majority, or more than 60, 70, or 80%, of the spirally arranged layers.

As mentioned above, neighboring stator teeth defines a tooth separation, or tooth gap, between them. The tooth separation may vary depending on the radius, or between layers. The tooth separation in the outermost layer may be greater than the tooth separation in the neighboring inner layer. The tooth separation in the innermost layer may be greater than the tooth separation in the neighboring outer layer. Worded differently, each of the stator teeth may have a tooth width. It is understood that the tooth width is tangential to the spirally layered structure. The tooth width may vary depending on the radius, or between layers. The tooth width at the outermost layer may be smaller than the tooth width at the neighboring inner layer. The tooth width at the innermost layer may be smaller than the tooth width at the neighboring outer layer. The features described here contribute to a radial profile, or radial cross-section, of the stator teeth with rounded corners. The rounded corners allow for the coils to be tighter wound on the teeth reducing the radial protrusion of the coils relative to the teeth.

The plurality of slots may comprise: a first subset of slots and a second subset of slots. The slots in the first subset may have equal slot widths and the slots in the second subset may have equal slot widths. The slot width or widths of the second subset is greater than the slot width or widths of the first subset. The proposed system may further comprise: a controller, or control unit, connected to the punching tool and the rolling tool. It is understood that the controller is arranged to control the function of the punching tool and the rolling tool. The controller may be configured for synchronizing the punching tool and the rolling tool such that the slots overlap in the spirally layered structure and forms the stator teeth at the first side of the metal strip. The controller may be configured to operate the punching tool and the rolling tool for varying the slot widths along the metal strip, or along the first side. The controller may be configured to operate the punching tool and the rolling tool for forming the first subset of slots and the second subset of slots.

In the proposed method, winding the metal strip may comprise: positioning the slots of the first subset in a first layer of the spirally layered structure, and positioning the slots of the second subset in a second layer of the spirally layered structure. In the proposed system, the controller may configured to operate the punching tool and the rolling tool for positioning the slots of the first subset in a first layer of the spirally layered structure, and for positioning the slots of the second subset in a second layer of the spirally layered structure. In the proposed axial flux stator core, the slots of the first subset may be positioned in a first layer of the spirally layered structure, and the slots of the second subset may be positioned in a second layer of the spirally layered structure.

The second layer may be positioned radially outside of the first layer. For example, the second layer may be the outermost layer and the first layer may be positioned between the innermost layer and the outermost layer. Alternatively, the second layer may be the innermost layer and the first layer may be positioned between the innermost layer and the outermost layer. The first layer and the second layer may be juxtaposed.

In the proposed method and axial flux stator core, the plurality of slots may be formed by a cooperating punch and die notching the first side of the metal strip. The punching tool in the proposed system may comprise a cooperating punch and die configured for notching the first side of the metal strip and form the plurality of slots. It is understood that a single notching forms a slot with fixed dimensions, or a fixed slot width. Worded differently, a notching has a notch width along the metal strip, or parallel to the first side of the metal strip.

Each slot of the first subset may be formed by a single notching. The controller may be configured to operate the punching tool and the rolling tool for forming each slot of the first subset by a single notching. Each slot of the second subset may be formed by a first notching, a shifting the metal strip relative to the punch and the die, and a second notching overlapping the first notching. The controller may be configured to operate the punching tool and the rolling tool for forming each slot of the second subset by a first notching, a shifting the metal strip relative to the punch and the die, and a second notching overlapping the first notching.

Worded differently, each slot in the first subset may be formed by notching a first number of times, and each slot in the second subset may be formed by notching a second number of times that is greater than the first number of times. The controller may be configured to operate the punching tool and the rolling tool for forming each slot in the first subset by notching a first number of times, and for forming each slot in the second subset by notching a second number of times that is greater than the first number of times. The notchings forming a slot may overlap. It is understood that this required the number of notchings to be greater than one. For example, each slot in the first subset may be formed by a single notching and each slot in the second subset may be formed by two overlapping notchings, or each slot in the first subset may be formed by two overlapping notchings and each slot in the second subset may be formed by three overlapping notchings.

More generally, the plurality of slots may comprise: a subset of slots, wherein each of the slots in the subset are formed by two or more overlapping notchings. The controller may be configured to operate the punching tool and the rolling tool for forming a subset of slots, wherein each of the slots in the subset are formed by two or more overlapping notchings. It is specified above that the plurality of slots may be formed by a cooperating punch and die notching the first side of the metal strip. It is understood that the overlapping notchings forming a slot have different positions along the metal strip, or parallel the first side of the metal strip. Worded differently, when forming a slot of the subset of slots, the metal strip may be shifted relative to the punch and die between the notchings, or the controller may be configured to operate the punching tool and the rolling tool to shift the metal strip relative to the punch and die between the notchings.

It is understood that each notching has a notch width along the metal strip, or parallel to the first side of the metal strip. The overlapping notchings thus form a slot having a slot width that is greater than notch width of a single notching. It is understood that the subset includes at least two slots. The number of notchings forming a slot of the subset may vary along the metal strip, or between slots of the subset of slots. Additionally or alternatively, the overlapping of the notchings forming a slot of the subset may vary along the metal strip, or between slots, or the relative positions between notchings forming a slot of the subset may vary along the metal strip, or between slots. Worded differently, the abovementioned shifting between the notchings may vary along the metal strip, or between slots of the subset of slots.

For example, a first slot of the subset may be formed by a first number of overlapping notchings. A second slot of the subset may be formed by a second number of overlapping notchings. It is understood that the first number and the second number are greater than one. The first number and the second number may be the same, and the relative position between the second number of notchings may be different from the relative position between the first number of notchings. Additionally or alternatively, the second number may be different from the first number. It is understood that the plurality of slots may further comprise: an additional subset of slots, wherein each of the slots in the additional subset are formed by a single notching or by two or more overlapping notchings. It is further understood that the controller may be configured to operate the punching tool and the rolling tool for forming an additional subset of slots, wherein each of the slots in the additional subset are formed by a single notching or by two or more overlapping notchings.

The proposed method may further comprise: forming one or more weld seams joining neighboring layers of the spirally layered structure. The proposed system may further comprise: a weld configured for forming one or more weld seams joining neighboring layers of the spirally layered structure. The proposed axial flux stator core may comprise one or more weld seams joining neighboring layers of the spirally layered structure. The weld seams may prevent the spirally layered structure from unwinding. The weld seams may extend radially relative to the spirally layered structure. Each weld seam may extend over all layers of the spirally layered structure. The weld seams may be located on the second side, or on the stator yoke.

It is specified that the metal strip forms an annular stator yoke connecting the stator teeth. Additionally, the second side of the metal strip may form the annular stator yoke. This means that the second side does not forms a plurality of additional stator teeth.

Alternatively, the method according to the first aspect of the proposed technology may further comprise: forming a plurality of additional slots in the second side of the metal strip, wherein each second slot has a slot width, and the slot widths vary, or change, along the metal strip, or the second side. In the second aspect of the proposed technology, the punching tool may further be configured for forming a plurality of additional slots in the second side of the metal strip, wherein each additional slot has a slot width and the slot widths vary, or change, along the metal strip, or the second side. In the third aspect of the proposed technology, the second side of the metal strip may have a plurality of additional slots, each additional slot has a slot width, and the slot widths vary, or change, along the metal strip, or the second side. In the fourth aspect of the proposed technology, the method may further comprise: forming, or winding, a coil of an electrically insulated conductor on each of the additional stator teeth. In the fifth aspect of the proposed technology, the axial flux stator may further comprise: a plurality of coils individually positioned on, or wound around, the additional stator teeth. Worded differently, each coil may be individually positioned on, or wound around, one of the stator teeth or the additional stator teeth. In the spirally layered structure, the second side may form a plurality of additional stator teeth, the additional slots define a tooth separation, or tooth gap, between each pair of neighboring additional stator teeth, and the annular stator yoke connects the additional stator teeth. The annular stator yoke may be positioned between the stator teeth and the additional stator teeth. The additional slots may have the same features or be provided in the same manner as the slots. Similarly, the additional stator teeth may have the same features or be provided in the same manner as the stator teeth.

### BRIEF DESCRIPTION OF THE DRAWINGS

A more complete understanding of the abovementioned and other features and advantages of the proposed technology will be apparent from the following detailed description of preferred embodiments of the proposed technology in conjunction with the appended drawings, wherein:

FIG. 1 is a schematic illustration of a system for manufacturing an axial flux stator core,

FIG. 2 is a perspective view of an axial flux stator core during manufacturing using the system of FIG. 1,

FIGS. 3a to 3c are plane projections showing the final geometry of the axial flux stator core of FIG. 2,

FIG. 4a is a plane projection showing the position of a coil on one of the stator teeth of the axial flux stator core of FIG. 2,

FIG. 4b is a plane projection showing the position of an alternative coil on one of the stator teeth of the axial flux stator core of FIG. 2, and

FIG. 5 is a perspective view of an axial flux stator core having additional stator teeth.

### DETAILED DESCRIPTION OF THE DRAWINGS

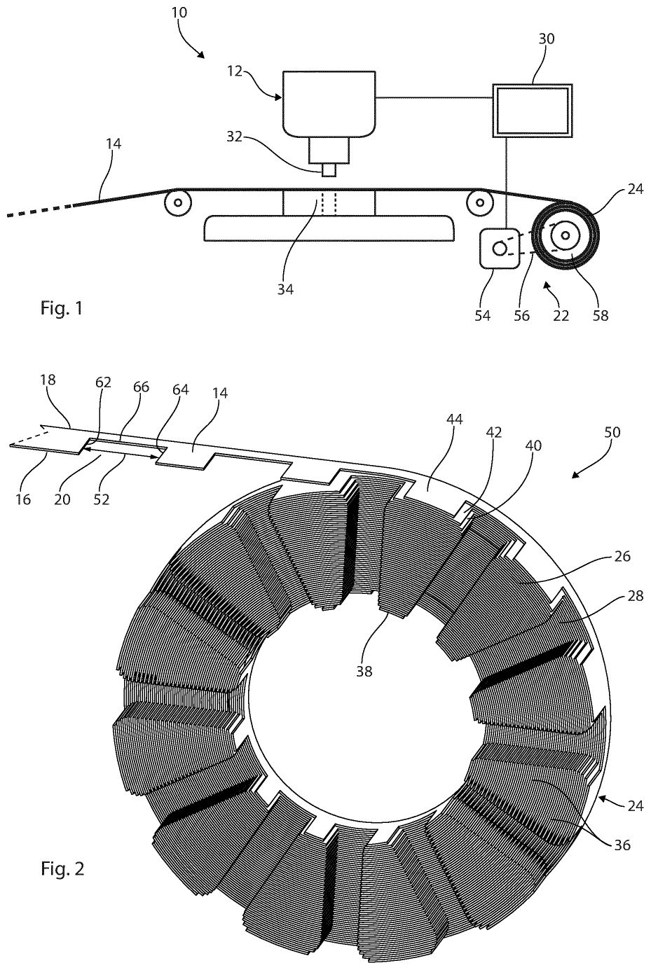

A system 10 for manufacturing an axial flux stator core 50 is schematically illustrated in FIG. 1. The system 10 has a punching tool 12 and a metal strip 14 of silicon steel is fed into the punching tool 12. The metal strip 14 has a longitudinal first side 16 and a longitudinal second side 18. The punching tool 12 has a cooperating punch 32 and die 34 that notch the first side 16 of the metal strip 14 and form a plurality of slots 20 at the first side 16.

The system 10 also has a rolling tool 22 with a roller 58 operationally connected to an electric motor 54 by a belt 56. The rolling tool 22 winds the metal strip 14 on the roller 58 after it has passed through the punching tool 12. This way a spirally layered structure 24 is formed having a plurality of spirally arranged and sandwiched layers 36 that contact one another.

The system 10 has a controller 30 connected to and synchronizing the punching tool 12 and the rolling tool 22 such that the slots 20 overlap in the spirally layered structure 24. This way, the first side 16 of the metal strip 14 forms a plurality of stator teeth 26 and the slots 20 define the tooth separation between neighboring pairs of stator teeth 26. The second side 18 of the metal strip 14 forms an annular stator yoke 26 that connects the stator teeth 26.

The controller 30 operates the punching tool 12 and the rolling tool 22 such that several subsets of slots 20 are formed. An initial subset is formed in which the slots 20 are positioned in the innermost layer 38 of the spirally layered structure 24. Each of the slots 20 in the initial subset are formed by the controller 30 operating the punching tool 12 and the rolling tool 22 to form the slot by punching a first notching, shifting the metal strip 14 relative to the punch 32 and the die 34, and punching a second notching overlapping the first notching. This way, a wider slot width is achieved than with a single notching. The shifting of the metal strip 14 is sequentially decreased, which means that the slot width varies along the metal strip 14 in the innermost layer 38. A second subset is formed in which the slots 20 are positioned between the innermost layer 38 and the third outermost layer 40. The controller 30 operates the punching tool 12 and the rolling tool 22 to form each of the slot 20 by a single notching by the punching tool 12, which means that the slots 20 of the second subset have the same slot width, and the slot width is narrower than in the initial subset. A third subset is formed in which the slots 20 are positioned in the third outermost layer 40. Each of the slots 20 in the third subset are formed by the controller 30 operating the punching tool 12 and the rolling tool 22 to form the slot 20 by punching a first notching, shifting the metal strip 14 relative to the punch 32 and the die 34, and punching a second notching overlapping the first notching. This way, a wider slot width is achieved than for the second subset. The shifting of the metal strip is the same for all the slots 20 of the third subset, which means that they have the same slot width. A fourth subset is formed in which the slots 20 are positioned in the second outermost layer 42. The slots 20 of the fourth subset are formed in the same manner as the slots 20 of the third subset, but with a greater shifting of the metal strip 14 between the first notching and the second notching resulting in a greater slot width. A final subset is formed in which the slots 20 are positioned in the outermost layer 44. The slots 20 of the final subset are formed in the same manner as the slots 20 of the fourth subset, but with a greater shifting of the metal strip 14 between the first notching and the second notching resulting in an even greater slot width. The slot width of a slot 20 is indicated by the double-headed arrow 52 in FIG. 2.

It should be noted that numbering of the layers and subsets corresponds to the radial position in the spirally layered structure 24 and that different numberings can be used not relating to the radial position. For example, the fourth outermost layer may be considered a first layer, the slots 20 in the fourth outermost layer may be considered a first subset, the third outermost layer 40 may be considered a second layer, and the slots 20 in the third outermost layer 40 may be considered a second subset. This means that the slots 20 in the first subset have equal slot widths formed by a single notching and the slots in the second subset have equal slot widths formed by two notchings, and the slot width of the second subset is greater than the slot width or widths of the first subset.

Each slot 20 defines a first slot edge 62, a second slot edge 64, and a third slot edge 66 on the metal strip 14. The first slot edge 62 and the second slot edge 64 are spaced apart and connected to the first side 16 of the metal strip 14, thus defining the slot width 52. The third slot edge 66 is spaced apart from the first side 16 and interconnects the first slot edge 62 and the second slot edge 64. The first slot edge 62 and the second slot edge 64 are straight and parallel. They are also perpendicular to the first side 16 of the metal strip 14. The third slot edge 66 is parallel to the first edge 16 of the metal strip 14. This way, each slot 20 outlines a rectangle with a slot width 52 that is constant transverse to the strip 14.

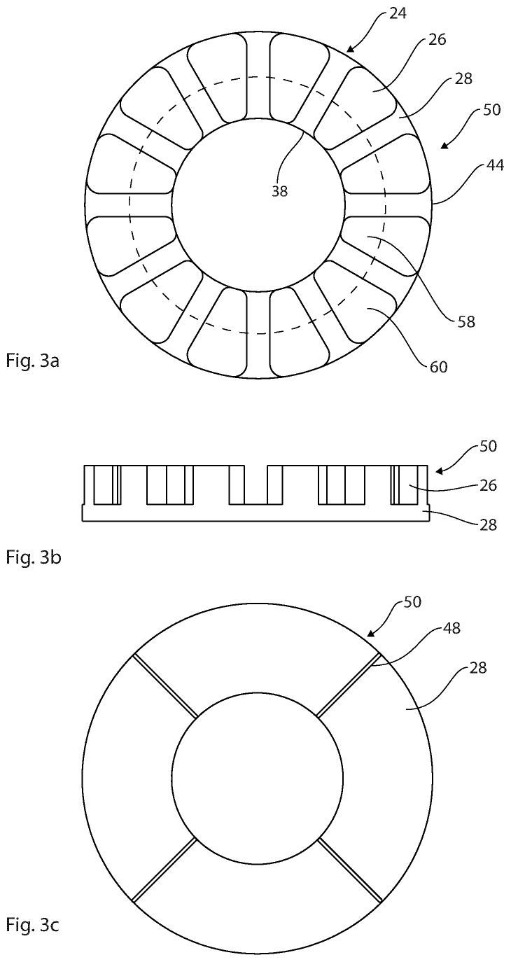

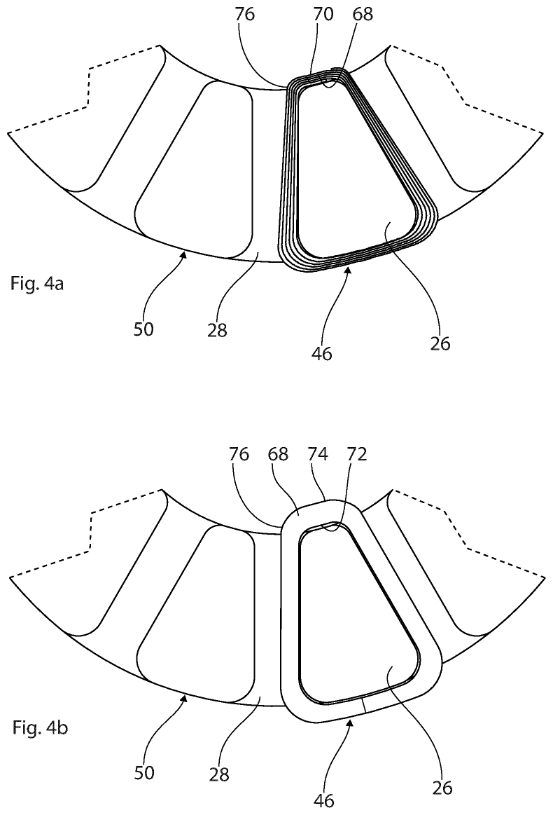

The resulting spirally layered structure 24 has an outermost layer 44 with slot widths that are greater than the slot width in the neighboring inner layer 42. The slot widths in the innermost layer 38 are equal to and greater than the slot width in the neighboring outer layer. This means that the tooth separation varies depending on the radius. Each of the stator teeth 26 has a tooth width aligned tangential to the spirally layered structure 24 and the tooth width varies depending on the radius. The tooth width at the outermost layer 44 is smaller than the tooth width at the neighboring inner layer 42, and the tooth width at the innermost layer 38 is smaller than the tooth width at the neighboring outer layer. The radial profile of the stator teeth 26 has rounded corners, which can be seen in FIG. 3a. This allows for a coil 46 to be tighter wound and protrude less radially relative to the stator teeth 26, as shown in FIG. 4.

In alternative embodiments, the number of notchings may be different and the overlapping between the notchings may be different. For example, the notching width of the punching tool 12 may be half as long as in the previous example. Each slot 20 of the initial subset are formed by three overlapping notchings with an even shifting between the notchings. Each slot 20 of the second subset are also formed by three overlapping notchings, but with a shorter shifting than for the initial subset. Each slot 20 of the third subset are formed by three overlapping notchings with a shifting similar to that of the initial subset. Each slot 20 of the fourth subset are formed by three overlapping notchings with a longer shifting between the notchings than for the initial subset. Each slot 20 of the final subset are formed by four overlapping notchings with an even shifting between the notchings.

The system 10 further has a weld (not shown) that forms four radially extending weld seams 48 on the stator yoke 28 joining neighboring layers of the spirally layered structure 24 and preventing it from unwinding once removed from the rolling tool, see further FIG. 3c.

The spirally arranged structure 24 has a radially inner half 58 and a radially outer half 60 that join at the middle between (dashed line) between the innermost layer 38 and the outermost layer 44, as is shown in FIG. 3a. The slot widths 52 of the slots 20 in the radially outermost layer 44 are greater than the slot widths 52 of the slots 20 in the other layers of the outer half 60, which can be seen in FIG. 2. Similarly, the slot widths 52 of the slots 20 in the radially innermost layer 38 are greater than the slot widths 52 of the slots 20 in the other layers of the inner half 58.

It is shown above that the system 10 performs a method in which an axial flux stator core 50 is manufactured from a metal strip 14 having a longitudinal first side 16 and a longitudinal second side 18. In summary, slots are formed in the first side 16 of the metal strip and the slot widths vary along the metal strip 14. The metal strip 14 is rolled to form a spirally layered structure 24 with the first side forming a plurality of stator teeth 26 and the second side forming an annular stator yoke 28 connecting the stator teeth 26.

The resulting axial flux stator core 50 has a spirally layered structure 24 formed by a rolled metal strip 14 having a longitudinal first side 16 and a longitudinal second side 18. The overall geometry of the stator core 50 is shown in FIGS. 3a to 3c. The first side 16 of the metal strip 14 has a plurality of slots 20 having a width that vary along the metal strip 14. The first side 16 forms a plurality of stator teeth 26 and the second side 18 forms an annular stator yoke 28 connecting the stator teeth 26.

To manufacture an axial flux stator (not shown), coils 46 of electrically insulated conductors 76 are wound on each of the stator teeth 26, as illustrated in FIG. 4a. The axial flux stator (not shown) can be installed in an axial flux motor or generator (not shown). Each conductor 76 is a coated flat copper strip that has a first broad side 68 and an opposite second broad side 70. These are interconnected by a first narrow side (not shown) and a second narrow side (not shown) that face in opposite directions (perpendicular to the plane of the sheet) and are perpendicular to the first broad side 68 and second broad side 70. The first broad side 68 is an inner side arranged to face the stator tooth 26. This way, the coil 46 constitutes a radially expanding multi-layer flat-conductor coil. An alternative embodiment is shown in FIG. 4b in which each conductor 76 is a coated flat copper strip but wound in a different manner. The coils 46 are prefabricated separate from the axial flux stator core 50, and the coils 46 are mounted by pushing them onto the stator teeth 26. In each coil 46, the first narrow side 72 of the flat copper strip is arranged to face the stator tooth 26 and the second narrow side 74 is arranged to face away from the stator tooth 26. The first broad side 68 and the opposite second broad side (not shown) face in opposite directions (perpendicular to the plane of the sheet) and are connected by the first narrow side 72 and the second narrow side 74. This means that the first narrow side 72 constitutes an inner face of the conductor 76. This way, the coil 46 is an axially expanding single-layer flat-conductor coil.

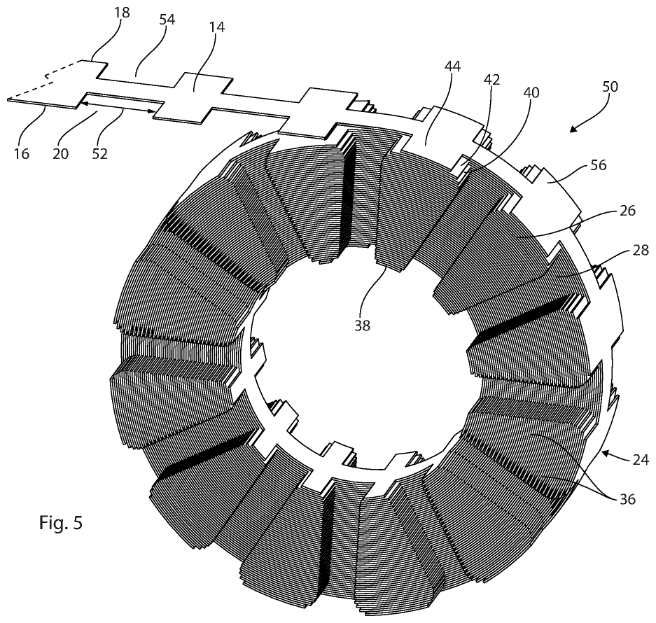

An alternative embodiment of a spirally layered structure 24 for an axial flux stator core 50 is shown in FIG. 5. The structure 24 has the features shown in FIG. 2. Additionally, it further has a plurality of additional teeth 56 formed by additional slots 54 in the second side 18 of the metal strip 14. The spirally layered structure 24 is manufactured by a system 10 similar to that described in relation to FIG. 1. The system 10 has an additional punching tool (not shown) with an additional cooperating punch (not shown) and die (not shown) that notch the second side 18 of the metal strip 14 and form the plurality of additional slots 54 in the second side 18. The slots on the first side 16 and the additional slot 54 on the second side 18 are arranged pairwise. The controller 30 of the system is connected to and controls the additional punching tool (not shown) such that in each pair the additional slot 54 is positioned right across from and has the same slot width 52 as the slot 20. The controller 30 operates the additional punching tool (not shown) in the same manner as the punching tool 12. For example, a varying slot width 52 is achieved by punching two overlapping notchings with the rolling tool 22 varying the shifting of the metal strip 14 between the notchings. When the rolling tool 22 forms the spirally layered structure 24, the additional slots 54 overlap in the same manner as the slots 20 and forms the additional teeth 56 at the second side 18.

### ITEM LIST

10 system
12 punching tool
14 metal strip
16 first side of metal strip
18 second side of metal strip
20 slots
22 rolling tool
24 spirally layered structure
26 stator teeth
28 stator yoke
30 controller
32 punch
34 die
36 layers
38 innermost layer
40 third outermost layer
42 second outermost layer
44 outermost layer
46 coil
48 weld seams
50 axial flux stator core
52 slot width
54 additional slots
56 additional teeth
58 radially inner half of spirally layered structure
60 radially outer half of spirally layered structure
62 first slot edge
64 second slot edge
66 third slot edge
68 first broad side
70 second broad side
72 first narrow side
74 second narrow side
76 conductor

1.-15. (canceled)

16. A method of manufacturing an axial flux stator core having a spirally layered structure from a metal strip having a longitudinal first side and a longitudinal second side, the method comprising:
forming a plurality of slots in the first side of the metal strip, wherein each slot has a slot width, wherein the slot widths vary along the first side of the metal strip, wherein the slots define a plurality of stator teeth in the first side of the strip, each neighboring pair of stator teeth being separated by one of the plurality of slots, and wherein the second side of the metal strip forms an annular stator yoke connecting the stator teeth; and
winding the metal strip to form a spirally layered structure.

17. The method according to claim 16, wherein each slot defines a first slot edge and a second slot edge on the metal strip, wherein the first slot edge and the second slot edge are spaced apart and connected to the first side of the metal strip, and wherein the first slot edge and the second slot edge are straight.

18. The method according to claim 16, wherein the spirally layered structure has a plurality of spirally arranged layers encompassing a radially outermost first layer and a radially innermost layer, and wherein the slot widths of the slots in the radially outermost first layer are greater than the slot widths of the slots in a second layer adjacent to and radially inwardly from the radially outermost first layer.

19. The method according to claim 18, wherein the slot widths of the slots in the second layer are greater than the slot widths of the slots in a third layer adjacent to and radially inward from the second layer.

20. The method according to claim 16, wherein the plurality of slots comprises a subset of slots, wherein each of the slots in the subset is formed by two or more overlapping notchings.

21. The method according to claim 16, wherein the plurality of slots comprises a first subset of slots and a second subset of slots, wherein all of the slots in the first subset have a first slot width, and all of the slots in the second subset have a second slot width, and wherein the second slot width is greater than the first slot width.

22. The method according to claim 21, wherein the plurality of slots is formed by notching the first side of the metal strip with a cooperating punch and die, the notching being performed by (a) forming each of the slots of the first subset by a single notching; and (b) forming each of the slots of the second subset by (i) forming a first notching of the strip, (ii) shifting the metal strip relative to the punch and the die, and (iii) forming a second notching of the strip that overlaps the first notching.

23. The method according to claim 16, further comprising:
forming a coil of an electrically insulated conductor on each of the stator teeth.

24. An axial flux stator core having a spirally layered structure, the axial flux stator core comprising a metal strip having a longitudinal first side and a longitudinal second side, the first side of the metal strip having a plurality of slots, wherein:
each of the slots has a slot width, wherein the slot widths vary along the metal strip;
the first side of the metal strip forms a plurality of stator teeth, the slots defining a tooth separation between each pair of neighboring stator teeth; and
the second side of the metal strip forms an annular stator yoke connecting the stator teeth.

25. The axial flux stator core according to claim 24, wherein each of the slots defines a first slot edge and a second slot edge on the metal strip, wherein the first slot edge and the second slot edge are spaced apart and connected to the first side of the metal strip, and wherein the first slot edge and the second slot edge are straight.

26. The axial flux stator core according to claim 24, wherein:
the spirally layered structure is formed of a plurality of layers spirally arranged between a radially outermost first layer and a radially innermost layer;
the slot widths of the slots in the radially outermost layer are greater than the slot widths in a second layer adjacent to and radially inward from the radially outermost first layer;
the slot width of the slots in the second layer are greater than the slot widths of the slots in a third layer adjacent to and radially inward from the second layer; and
the slot widths are the same in and between a majority of the layers between the third layer and the radially innermost layer.

27. The axial flux stator core according claim 24, wherein the plurality of slots comprises a first subset of slots and a second subset of slots, the slots in the first subset having equal slot widths, and the slots in the second subset having equal slot widths, the slots of the first subset being positioned in a first layer of the spirally layered structure, the slots of the second subset being positioned in a second layer of the spirally layered structure, wherein the slot widths of the slots in the second subset are greater than the slot widths of the slots in first subset, and wherein the second layer is radially outward from the first layer.

28. The axial flux stator according to claim 24, further comprising a coil of an electrically insulated conductor on each of the stator teeth.

29. A system for manufacturing an axial flux stator core from a metal strip having a longitudinal first side and a longitudinal second side, wherein the system comprises:
a punching tool configured for forming a plurality of slots in the first side of the metal strip, wherein each of the slots has a slot width, and wherein the slot widths vary along the metal strip; and
a rolling tool configured for winding the metal strip to form a spirally layered structure, wherein the first side of the strip forms a plurality of stator teeth, each of the slots defines a tooth separation between each pair of neighboring stator teeth, and the second side of the strip forms an annular stator yoke connecting the stator teeth.

30. An axial flux motor or generator, comprising:
an axial flux stator core comprising a metal strip formed into a spirally layered structure, the metal strip having a longitudinal first side and a longitudinal second side;
wherein the first side of the metal strip has a plurality of slots, each of the slots having a slot width, the slot widths varying along the metal strip, each of the slots defining a separation between a pair of stator teeth;
wherein the second side of the strip forms an annular stator yoke connecting the stator teeth; and
wherein a coil of an electrically insulated conductor is located on each of the stator teeth.

31. The axial flux motor or generator according to claim 30, wherein each slot defines a first slot edge and a second slot edge on the metal strip, wherein the first slot edge and the second slot edge are spaced apart and connected to the first side of the metal strip, and wherein the first slot edge and the second slot edge are straight.

32. The axial flux motor or generator according to claim 30, wherein:
the spirally layered structure is formed of a plurality of layers spirally arranged between a radially outermost first layer and a radially innermost layer;
the slot widths of the slots in the outermost layer are greater than the slot widths in a second layer adjacent to and radially inward from the radially outermost first layer;
the slot width of the slots in the second layer are greater than the slot widths of the slots in a third layer adjacent to and radially inward from the second layer; and
the slot widths are the same in and between a majority of the layers between the third layer and the radially innermost layer.

33. The axial flux motor or generator according to claim 30, wherein the plurality of slots comprises a first subset of slots and a second subset of slots, the slots in the first subset having equal slot widths, and the slots in the second subset having equal slot widths, the slots of the first subset being positioned in a first layer of the spirally layered structure, the slots of the second subset being positioned in a second layer of the spirally layered structure, wherein the slot widths of the slots in the second subset are greater than the slot widths of the slots in first subset, and wherein the second layer is radially outward from the first layer.
